(19) United States
(12) Patent Application Publication
(10) Pub. No.: US 2022/0291002 A1
(43) Pub. Date: Sep. 15, 2022

(54) METHOD FOR DETERMINING ROAD INFORMATION

(71) Applicant: Apollo Intelligent Connectivity (Beijing) Technology Co., Ltd, Beijing (CN)

(72) Inventor: Junfa WU, Beijing (CN)

(21) Appl. No.: 17/830,029

(22) Filed: Jun. 1, 2022

(30) Foreign Application Priority Data
Jun. 9, 2021 (CN) 202110640562.2

(51) Int. Cl. G01C 21/34; G01C 21/36

(52) U.S. Cl. CPC G01C 21/3461; G01C 21/3492; G01C 21/367

(57) ABSTRACT

The present disclosure provides a method for determining road information, and relates to the technical field of intelligent transport and navigation. A specific embodiment includes: acquiring current positioning information of a terminal; determining a positioning error threshold of the current positioning information based on a historical positioning error value of historical positioning information of the terminal in a latest preset historical period; and obtaining road information for use as target road information by matching, wherein a positioning error value between the road information and the current positioning information satisfies the positioning error threshold, and the road information includes at least one of: a road network unit, a driving route unit, or the current positioning information.

### CROSS-REFERENCE TO RELATED APPLICATION

The present application claims the priority of Chinese Patent Application No. 202110640562.2, titled “METHOD AND APPARATUS FOR DETERMINING ROAD INFORMATION”, filed on Jun. 9, 2021, the content of which is incorporated herein by reference in its entirety.

### TECHNICAL FIELD

The present disclosure relates to the technical field of computers, specifically to the technical field of intelligent transport and navigation, and more specifically to a method for determining road information.

### BACKGROUND

In the field of intelligent driving technology, vehicle-machine map matching is a very critical module, and mainly plays a role in binding positioning information (i.e., GPS information) with road information, which is referred to as road binding for short.

### SUMMARY

The present disclosure provides a method for determining road information, an electronic device, and a storage medium.

According to a first aspect, a method for determining road information, applied to a terminal, is provided, including: acquiring current positioning information of the terminal; determining a positioning error threshold of the current positioning information based on a historical positioning error value of historical positioning information of the terminal in a latest preset historical period; and obtaining road information for use as target road information by matching, wherein a positioning error value between the road information and the current positioning information satisfies the positioning error threshold, and the road information includes at least one of: a road network unit, a driving route unit, or the current positioning information.

According to a second aspect, an electronic device is provided, including: at least one processor; and a memory communicatively connected to the at least one processor; where the memory stores instructions executable by the at least one processor, and the instructions, when executed by the at least one processor, cause the at least one processor to execute the method according to any one embodiment of the method for determining road information.

According to a third aspect, a non-transitory computer readable storage medium storing computer instructions is provided, where the computer instructions are used for causing a computer to execute the above method according to any one embodiment of the method for determining road information.

### BRIEF DESCRIPTION OF THE DRAWINGS

After reading detailed descriptions of non-limiting embodiments with reference to the following accompanying drawings, other features, objectives and advantages of the present disclosure will become more apparent.

FIG. 1 is a diagram of an example system architecture in which some embodiments of the present disclosure may be implemented;

FIG. 2 is a flowchart of an embodiment of a method for determining road information according to the present disclosure;

FIG. 3 is a schematic diagram of an application scenario of the method for determining road information according to the present disclosure;

FIG. 4 is a flowchart of another embodiment of the method for determining road information according to the present disclosure;

FIG. 5 is a schematic structural diagram of an embodiment of an apparatus for determining road information according to the present disclosure; and

FIG. 6 is a block diagram of an electronic device configured to implement the method for determining road information according to embodiments of the present disclosure.

### DETAILED DESCRIPTION OF EMBODIMENTS

Example embodiments of the present disclosure are described below with reference to the accompanying drawings, where various details of the embodiments of the present disclosure are included to facilitate understanding, and should be considered merely as examples. Therefore, those of ordinary skills in the art should realize that various changes and modifications can be made to the embodiments described here without departing from the scope and spirit of the present disclosure. Similarly, for clearness and conciseness, descriptions of well-known functions and structures are omitted in the following description.

In the technical solutions of the present disclosure, the acquisition, storage, and application of personal information of a user involved are in conformity with relevant laws and regulations, and do not violate public order and good customs because of adopting necessary security measures.

It should be noted that some embodiments in the present disclosure and some features in the embodiments may be combined with each other on a non-conflict basis. The present disclosure will be described in detail below with reference to the accompanying drawings and in combination with the embodiments.

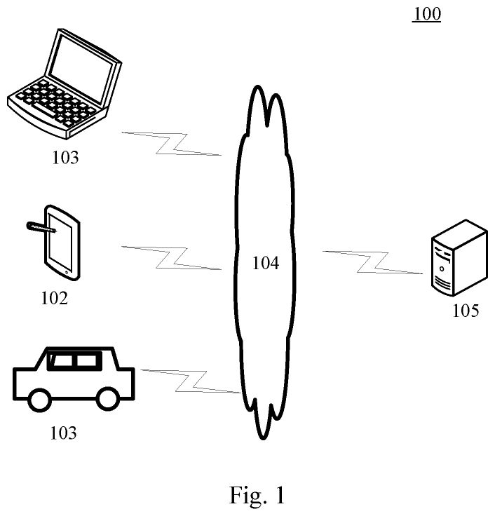

FIG. 1 shows an example system architecture 100 in which a method for determining road information or an apparatus for determining road information according to embodiments of the present disclosure may be implemented.

As shown in FIG. 1, the system architecture 100 may include terminal devices 101, 102, and 103, a network 104, and a server 105. The network 104 serves as a medium providing a communication link between the terminal devices 101, 102, and 103, and the server 105. The network 104 may include various types of connections, such as wired or wireless communication links, or optical cables.

A user may interact with the server 105 using the terminal devices 101, 102, and 103 via the network 104, e.g., to receive or send a message. The terminal devices 101, 102, and 103 may be provided with various communication client applications, such as a video application, a live broadcast application, an instant messaging tool, an email client, and social platform software.

The terminal devices 101, 102, and 103 here may be hardware, or may be software. When the terminal devices 101, 102, and 103 are hardware, the terminal devices may be various electronic devices having display screens, including but not limited to a vehicle, a smart phone, a tablet computer, an ebook reader, a laptop portable computer, a desktop computer, and the like. When the terminal devices 101, 102, and 103 are software, the terminal devices may be installed in the above-listed electronic devices. The terminal devices may be implemented as a plurality of software programs or software modules (e.g., a plurality of software programs or software modules configured to provide distributed services), or may be implemented as a single software program or software module. This is not specifically limited here.

The server 105 may be a server providing various services, such as a back-end server providing support for the terminal devices 101, 102, and 103. The back-end server may process, e.g., analyze, data such as received current positioning information, and return the processing result (e.g., update information of a positioning error threshold) to the terminal devices.

It should be noted that the method for determining road information provided in the embodiments of the present disclosure may be executed by the server 105 or the terminal devices 101, 102, and 103. Accordingly, the apparatus for determining road information may be provided in the server 105 or the terminal devices 101, 102, and 103.

It should be understood that the numbers of terminal devices, network, and server in FIG. 1 are merely illustrative. Any number of terminal devices, networks, and servers may be provided based on actual requirements.

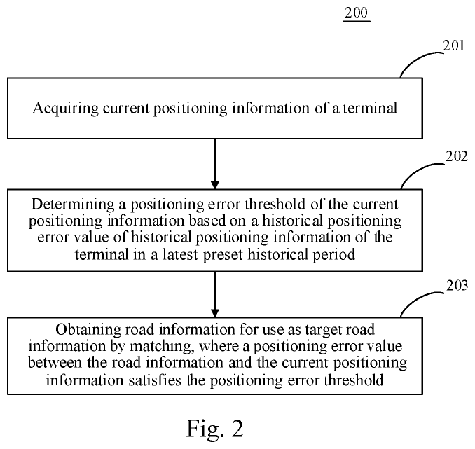

Further referring to FIG. 2, a process 200 of an embodiment of a method for determining road information according to the present disclosure is shown. The method for determining road information, applied to a terminal, includes the following steps:

Step 201: acquiring current positioning information of the terminal.

In the present embodiment, an executing body (e.g., the terminal device shown in FIG. 1) on which the method for determining road information runs may acquire the current positioning information of the terminal, i.e., the current positioning information. The terminal at which this method is used may be a vehicle or a terminal device other than a vehicle, e.g., a mobile terminal such as a mobile phone.

In practice, positioning information of the terminal is position information of the terminal obtained through positioning by a module (such as a GPS module or a Beidou module) that has a positioning function on the terminal.

Step 202: determining a positioning error threshold of the current positioning information based on a historical positioning error value of historical positioning information of the terminal in a latest preset historical period.

In the present embodiment, the executing body may determine a positioning error threshold of the positioning information based on a historical positioning error value of historical positioning information of the terminal. The positioning error threshold here refers to a threshold defined for a value of positioning information deviating from a traveling road (a road network or a driving route). If the value of the positioning information deviating from a certain road exceeds the threshold, the road cannot be bound to the terminal.

The executing body may use an error value within the latest preset historical period to determine the historical positioning error value, where the error value may specifically be a value such as a variance, a standard deviation, and an average value. In the present disclosure, the error value and the positioning error threshold (e.g., the positioning error value, and the historical positioning error value) may be obtained by wave filtering.

For example, the executing body may determine errors between positioning information and a traveling route within the latest historical 30S, calculate a standard deviation of these errors, and use the obtained variance of the errors as the historical positioning error value. The error value may include at least one value indicating an error between the road information and the positioning information. For example, the error value may include a distance of projecting the positioning information onto the road information.

As an example, an original value of the historical positioning error value may be provided by a server. For example, the historical positioning error values corresponding to various machine types (vehicle types) may be identical.

In practice, the executing body may determine the positioning error threshold of the current positioning information based on the historical positioning error value by various approaches. For example, the positioning error threshold of the current positioning information is determined jointly based on the historical positioning error value and an existing positioning error threshold. For example, if the historical positioning error value is smaller than the existing positioning error threshold, the existing positioning error value is increased to obtain the positioning error threshold of the current positioning information, where the positioning error threshold is greater than the historical error threshold. If the historical positioning error value is greater than the existing positioning error threshold, the existing positioning error value is decreased. Alternatively, the executing body may input a current road type and the current positioning information into a preset model to obtain the positioning error threshold outputted from the preset model. The preset model may predict the positioning error threshold based on the current road type and the current positioning information.

Step 203: obtaining road information for use as target road information by matching, wherein a positioning error value between the road information and the current positioning information satisfies the positioning error threshold, and the road information includes at least one of: a road network unit, a driving route unit, or the current positioning information.

In the present embodiment, the executing body may obtain the target road information for the current positioning information based on the positioning error threshold, and the positioning error value between the target road information and the current positioning information satisfies the positioning error threshold. The road information here may include at least one of: a unit of a road network, a unit of a driving route obtained by navigation, or the current positioning information. Specifically, the unit of the driving route refers to a road section in the driving route, and the unit of the road network refers to a road section in the road network (i.e., a road section in a road of the road network).

In practice, the executing body may acquire a predetermined value determination condition between the positioning error value and the positioning error threshold, i.e., a condition for determining whether the positioning error value satisfies the positioning error threshold. For example, the condition may be that the positioning error value is smaller than the positioning error threshold, and then the positioning error value satisfies the positioning error threshold, or the condition may be that the positioning error value is greater than the positioning error threshold, and then the positioning error value satisfies the positioning error threshold.

The positioning error value is an error value corresponding to the current positioning information. The positioning error threshold is a threshold set for the positioning error value.

The method provided in the above embodiments of the present disclosure can determine the positioning error threshold in real time, thereby matching more accurate road information based on the latest positioning information error.

In some alternative implementations of the present embodiment, the determining the positioning error threshold of the current positioning information based on the historical positioning error value of the historical positioning information of the terminal in the latest preset historical period in step 202 may include: acquiring a current road type of the terminal; and determining the positioning error threshold of the current positioning information based on the historical positioning error value and the current road type.

In the present embodiment, the executing body may acquire the current road type of the terminal, and may determine the positioning error threshold of the current positioning information based on the historical positioning error value and the current road type. The current road type refers to a type of a road (i.e., a road section) on which the terminal is located. The current road type may be acquired by the executing body in various ways, for example, by sending a road type request to the server, and receiving the current road type returned from the server. The road type may be preset various road types. For example, the road type may be a tunnel, a ring road, and the like. A road curvature of the tunnel is relatively small, and a road curvature of the ring road is large.

In practice, the executing body may determine the positioning error threshold of the current positioning information based on the historical positioning error value and the current road type by various approaches. For example, the executing body may input the historical positioning error value and the current road type into a pre-trained specified model (such as a deep neural network) to obtain a positioning error threshold outputted from the specified model. The specified model may predict the positioning error threshold based on the historical positioning error value and the current road type. Alternatively, in the case where the positioning error threshold may be a distance threshold and an angle threshold, each current road type may have an adjustment trend corresponding to a positioning error threshold. For example, if the current road type is a ring road, an adjustment trend corresponding to the ring road is to decrease the distance threshold and increase the angle threshold. If the current road type is a tunnel, an adjustment trend corresponding to the tunnel is to increase the distance threshold and decrease the angle threshold.

These implementations can more accurately determine the positioning error threshold based on the current road type.

Alternatively, the acquiring the current road type of the terminal may include: using a road type of road information matched in a previous road matching cycle as the current road type.

In these alternative implementations, when entering the road matching cycle, the executing body may execute step 201 to step 203 to match the road information. The road information indicates a road. Therefore, the executing body may obtain a road type indicated by the road information matched in the last road matching cycle (for example, 1 second or 0.5 second). In addition, the executing body may use the road type as the current road type, i.e., as the road type in a current road matching cycle.

These implementations may use a road type corresponding to the previous road matching cycle as the current road type, thereby improving the accuracy of the current road type as far as possible.

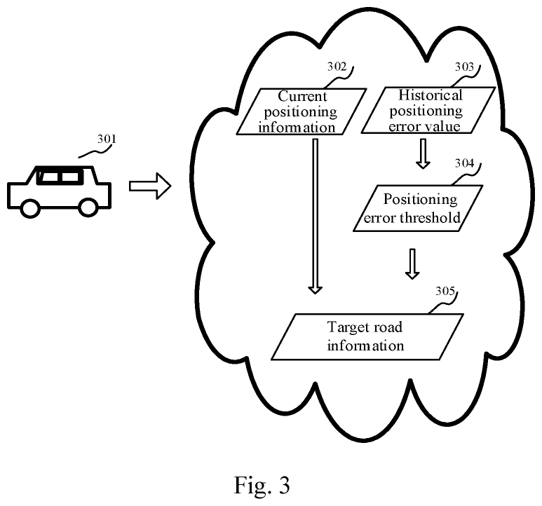

Further referring to FIG. 3, FIG. 3 is a schematic diagram of an application scenario of the method for determining road information according to the present embodiment. In the application scenario of FIG. 3, an executing body 301 acquires current positioning information 302 of a terminal. The executing body 301 determines a positioning error threshold 304 of the current positioning information 302 based on a historical positioning error value 303 of the positioning information of the terminal in a latest preset historical period. The executing body 301 obtains road information or use as target road information 305 by matching, wherein a positioning error value between the road information and the current positioning information 302 satisfies the positioning error threshold 304, and the road information includes at least one of: a road network unit, a driving route unit, or the current positioning information.

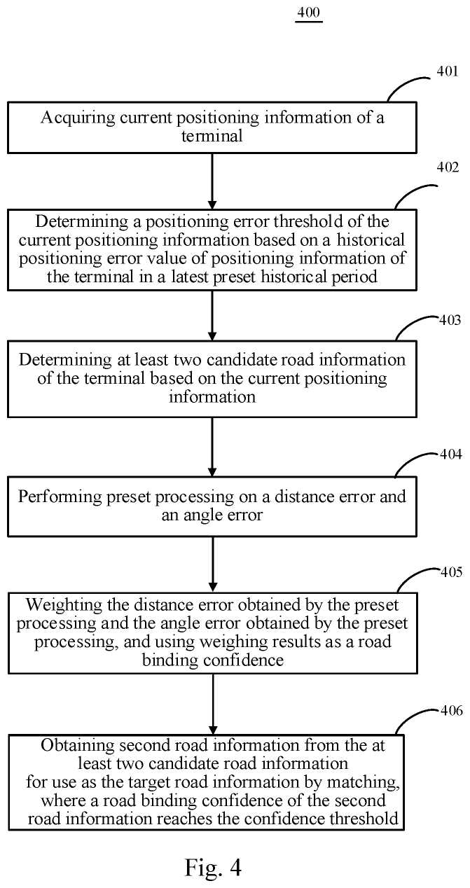

Further referring to FIG. 4, a process 400 of another embodiment of the method for determining road information is shown. In the process 400, the historical positioning error value includes a historical error variance, and the method may include the following steps:

Step 401: acquiring current positioning information of the terminal.

In the present embodiment, an executing body (e.g., the terminal device shown in FIG. 1) on which the method for determining road information runs may acquire the current positioning information of the terminal, i.e., the current positioning information. The positioning error threshold includes a confidence threshold, and the positioning error value includes a distance error and an angle error.

Step 402: determining a positioning error threshold of the current positioning information based on a historical positioning error value of historical positioning information of the terminal in a latest preset historical period.

In the present embodiment, the executing body may determine a positioning error threshold of the positioning information based on a historical positioning error value of historical positioning information of the terminal. The positioning error threshold here refers to a threshold defined for a value of positioning information deviating from a traveling road (a road network or a driving route).

Step 403: determining at least two candidate road information of the terminal based on the current positioning information.

In the present embodiment, the executing body may determine at least two candidate road information of the terminal based on the current positioning information. That is, a terminal device first performs rough matching on the road information, and obtains at least two matching results.

Step 404: performing preset processing on a distance error and an angle error, where, for the distance error and the angle error, the higher a value of the distance error or the angle error is, the smaller a result obtained by the preset processing is.

In the present embodiment, the executing body may perform the preset processing on the distance error and the angle error. The higher the value of the distance error or the angle error used in the preset processing is, the smaller the result obtained by the preset processing is. That is, the larger the error is, the smaller the result obtained by the preset processing is.

The above preset processing may include various processing approaches, such as normalization. In practice, the preset processing may not only include normalization, but also may include a specified processing step before the normalization, and normalize the result of the specified processing step. The specified processing step may be, e.g., inputting the distance error and the angle error into a preset equation or multiplying the distance error and the angle error by a specified coefficient. Many approaches may be used for normalization, for example, may be using a complementary error function for computation. Alternatively, the preset processing may also be, e.g., computing a reciprocal.

Step 405: weighting the distance error obtained by the preset processing and weighting the angle error obtained by the preset processing, and using weighting results as a road binding confidence.

In the present embodiment, the executing body may acquire a weight of the distance error obtained by the preset processing and a weight of the angle error obtained by the preset processing, weight the distance error obtained by the preset processing and weight the angle error obtained by the preset processing, and use the weighting results as the road binding confidence.

Step 406: obtaining second road information from the at least two candidate road information for use as the target road information by matching, wherein a road binding confidence reaches a confidence threshold.

In the present embodiment, the executing body may obtain the target road information from the at least two candidate road information by matching. Specifically, the target road information is the road information with the road binding confidence reaching the confidence threshold.

The present embodiment may determine road information with a small error and a high confidence for use as the target road information, thereby improving the accuracy of the road information.

Alternatively, the above method may further include: determining, for the at least two candidate road information, the weight of the distance error and the weight of the angle error based on a distance error variance and an angle error variance.

In the present embodiment, the historical positioning error value includes the distance error variance and the angle error variance. The executing body may determine, for candidate road information (e.g., each candidate road information) in the at least two candidate road information, the weight of the distance error of the candidate road information and the weight of the angle error of the candidate road information based on the distance error variance and the angle error variance.

In practice, the executing body may determine the weights based on the distance error variance and the angle error variance by various approaches. For example, the executing body may input the distance error variance and the angle error variance into a pre-trained model (such as a deep neural network), and obtain the weight of the distance error and the weight of the angle error outputted from the model. The model may predict the weight of the distance error and the weight of the angle error based on the distance error variance and the angle error variance. In addition, the executing body may alternatively determine the weights using a preset equation, for example, may substitute the distance error variance, the angle error variance, and existing weights of the distance error and the angle error into the equation, and obtain the weight of the distance error and the weight of the angle error.

Compared with the existing weights of the distance error and the angle error, the weights determined for the distance error and the angle error are closer to the distance error variance and the angle error variance respectively.

These alternative implementations may determine the weights based on the historical positioning error value in real time, such that the determined weights are more consistent with the actual conditions of current traveling.

Alternatively, the positioning error threshold further includes a distance error threshold and an angle error threshold; and the obtaining the second road information for use as the target road information by matching, wherein the road binding confidence reaches the confidence threshold includes: obtaining candidate road information by matching, wherein for the candidate road information, a normalized distance error reaches the distance error threshold, a normalized angle error reaches the angle error threshold, and a road binding confidence reaches the confidence threshold, and using road information corresponding to the candidate road information as the target road information.

In these alternative implementations, the candidate road information matched by the executing body has the normalized distance error reaching the distance error threshold, the normalized angle error reaching the angle error threshold, and the road binding confidence reaching the confidence threshold.

These alternative implementations may determine road information with a small distance error, a small angle error, and a small weighting result of the distance error and the angle error, thereby effectively improving the accuracy of the determined road.

In some alternative implementations of any one embodiment of the present disclosure, the obtaining the road information by matching, wherein the positioning error value between the road information and the current positioning information satisfies the positioning error threshold may include: uploading a threshold updating request to a server, and receiving update information about the positioning error threshold returned from the server; and updating the positioning error threshold using the update information to obtain an updated positioning error threshold, and obtaining the road information by matching, wherein the positioning error value between the road information and the current positioning information satisfies the updated positioning error threshold.

In these alternative implementations, the executing body may upload the threshold updating request to the server, and receive update information returned from the server. The update information is used for updating the positioning error threshold. Then, the executing body may update the positioning error threshold using the update information, such that the executing body may obtain the road information satisfying the updated positioning error threshold by matching.

In practice, the update information is information used for updating the positioning error threshold. Specifically, the updated positioning error threshold may be determined based on the update information and the positioning error threshold determined by the terminal. For example, the update information and the positioning error threshold may be inputted into a model or equation to obtain the updated positioning error threshold. In addition, the update information may be a positioning error threshold after the updating, i.e., the updated positioning error threshold itself, or may be a difference value between the updated positioning error threshold and an existing positioning error threshold, i.e., an adjustment range, or may be a computing approach of computing the updated positioning error threshold based on the existing positioning error threshold.

These implementations may update the threshold using the server, thereby further improving the accuracy of the threshold.

Alternatively, the threshold updating request includes a trajectory of the terminal and the target road information; and the uploading the threshold updating request to the server may include: uploading the threshold updating request to the server, where the server determines, based on the trajectory, the road information of the terminal as reference road information, and generates the update information about the positioning error threshold based on the reference road information and the target road information.

In these alternative implementations, the executing body may upload the trajectory of the terminal and the target road information to the server, such that the server may match the terminal with a piece of road information, i.e., the reference road information, and generate the update information based on the reference road information and the target road information.

In practice, the executing body may generate the update information based on the reference road information and the target road information by various approaches. For example, the executing body may compare the target road information with the reference road information, and directly use a difference value obtained from the comparison as the update information. Alternatively, the executing body may perform preset processing on the difference value, and use the result of the preset processing as the update information. The preset processing here may be, e.g., inputting the difference value into a preset equation, or multiplying the difference value by a preset coefficient. In addition, the executing body may alternatively input the reference road information and the target road information into a trained model, and obtain update information outputted from the model. The model may predict the update information based on the reference road and the target road information.

Specifically, the reference road information and the target road information may exist respectively in the forms of a plurality of points, where if there are some unmatching points between the reference road information and the target road information on the terminal, update information may be generated based on these unmatching points.

These alternative implementations may determine the road information based on the trajectory of the terminal. The trajectory eliminates a local error of the road information determined by the terminal in real time, and determines more accurate road information relative to the terminal, thereby accurately correcting the positioning error threshold based on the update information.

In some alternative implementations of any one embodiment of the present disclosure, after the determining the positioning error threshold of the current positioning information, the method further includes: generating a new positioning error threshold based on the following parameters of a current road matching cycle: a positioning error threshold determined by the terminal, a confidence of the positioning error threshold, the number of iterations of the positioning error threshold at the terminal, a reference positioning error threshold determined by the server, a confidence of the reference positioning error threshold, and the number of iterations of the reference positioning error threshold at the server.

In these alternative implementations, the executing body may generate a new positioning error threshold based on the above parameters, and correct the positioning error threshold using the new positioning error threshold. The corrected positioning error threshold is the new positioning error threshold.

The executing body may generate the new positioning error threshold by various approaches, for example, by inputting the above parameters into a pre-trained model, and obtaining a new positioning error threshold outputted from the model. The model may predict the new positioning error threshold.

In some application scenarios, the positioning error threshold determined by the terminal may be set as A1 (for example, the positioning error threshold determined in step 202), the confidence of the positioning error threshold may be set as X1, and the number of iterations of the positioning error threshold at the terminal may be set as N1. The reference positioning error threshold determined by the server is A2, a confidence of the reference positioning error threshold is X2, and the number of iterations of the reference positioning error threshold at the server is N2. Accordingly, the new positioning error threshold may be expressed as:

(N1*A1*X1+N2*A2*X2)/(N1*X1+N2*X2),

where “*” is multiplication, and the confidence refers to a confidence degree of the positioning error threshold. With the increase of the number of iterations, the confidence increases. The iteration refers to the number of times of determining the positioning error threshold on an electronic device, and the determining the positioning error threshold will generally be iterated on the basis of the existing positioning error threshold.

These implementations may correct the positioning error threshold of the terminal using the reference positioning error threshold of the server, thereby improving the accuracy of the positioning error threshold.

Alternatively, the generating the reference positioning error threshold includes: generating the reference positioning error threshold based on the following parameters of the current road matching cycle: the positioning error threshold determined by the terminal, timeliness of the positioning error threshold, the number of iterations of the positioning error threshold at the terminal, a to-be-corrected positioning error threshold determined by the server, timeliness of the to-be-corrected positioning error threshold, and the number of iterations of the to-be-corrected positioning error threshold at the server.

Specifically, the server may receive the positioning error threshold determined by the terminal, and then determine the reference positioning error threshold. Specifically, the reference positioning error threshold may be determined by various approaches, for example, by inputting these parameters into a trained model, and obtaining the reference positioning error threshold outputted from the model. The model may predict the reference positioning error threshold.

In some application scenarios, the positioning error threshold determined by the terminal may be set as A1, the number of iterations of the positioning error threshold at the terminal may be set as N1, and the timeliness of the positioning error threshold determined by the terminal may be set as B1. The to-be-corrected positioning error threshold determined by the server may be set as A2, the number of iterations of the to-be-corrected positioning error threshold may be set as N2, the timeliness of the to-be-corrected positioning error threshold may be set as B2, and then the update information may be:

(N1*A1*B1+N2*A2*B2)/(N1*B1+N2*B2)

where “*” is multiplication, the timeliness parameter may indicate the timeliness of the positioning error threshold, and the value of the timeliness parameter of the positioning error threshold gradually decreases over time.

The to-be-corrected positioning error threshold determined by the server may be determined by various approaches, for example, by using the historical positioning error value and a preset model for predicting the positioning error threshold using the historical positioning error value, or using the current positioning information and a preset model for predicting the positioning error threshold using the current positioning information.

These implementations can accurately determine the reference positioning error threshold.

In some alternative implementations of any one embodiment of the present disclosure, the road information is a road network unit, a driving route unit, or positioning information; and the obtaining the road information by the matching, where the positioning error value between the road information and the current positioning information satisfies the positioning error threshold includes: matching the current positioning information with the driving route; using, in response to obtaining a matching driving route, the matching driving route as the target road information; and matching, in response to not obtaining the matching driving route, the positioning information with the road network; using, in response to obtaining a matching road network, the matching road network as the target road information; and using, in response to not obtaining the matching road network, the current positioning information as the target road information.

In these alternative implementations, the executing body may first match the driving route unit. If the driving route unit is matched, i.e., it is determined that a driving route unit exists in an area where the current positioning information is located, where a positioning error value between the driving route unit and the current positioning information reaches the position error threshold, the executing body may use the driving route unit as the target road information. If no driving route unit is matched, i.e., a positioning error value between any driving route unit in the area where the current positioning information is located and the current positioning information does not reach the positioning error threshold, the executing body may match the road network unit.

In practice, if the road network unit is matched, i.e., it is determined that a positioning error value between a road network unit in the area where the current positioning information is located and the current positioning information reaches the positioning error threshold, the executing body may use the road network unit as the target road information. If no road network unit is matched, i.e., a positioning error value between any road network unit in the area where the current positioning information is located and the current positioning information does not reach the positioning error threshold, the executing body may directly use the above current positioning information as the target road information.

Specifically, the driving route unit and the road network unit may have corresponding positioning error thresholds respectively.

These alternative implementations can preferentially match the driving route unit, then match the road network unit, and use the current positioning information as the last choice, thereby contributing to determining accurate and detailed road information in the navigation process.

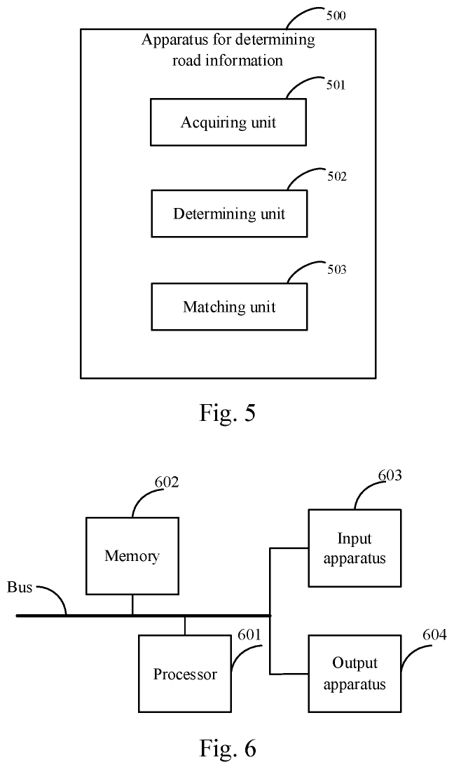

Further referring to FIG. 5, as an implementation of the method shown in the above figures, an embodiment of the present disclosure provides an apparatus for determining road information. The embodiment of the apparatus corresponds to the embodiment of the method shown in FIG. 2. Besides the features disclosed below, the embodiment of the apparatus may further include features or effects identical or corresponding to the embodiment of the method shown in FIG. 2. The apparatus may be specifically applied to various electronic devices.

As shown in FIG. 5, the apparatus 500 for determining road information of the present embodiment includes: an acquiring unit 501, a determining unit 502, and a matching unit 503. The acquiring unit 501 is configured to acquire current positioning information of the terminal; the determining unit 502 is configured to determine a positioning error threshold of the current positioning information based on a historical positioning error value of historical positioning information of the terminal in a latest preset historical period; and the matching unit 503 is configured to obtain road information for use as target road information by matching, wherein a positioning error value between the road information and the current positioning information satisfies the positioning error threshold, and the road information includes at least one of: a road network unit, a driving route unit, or the current positioning information.

In the present embodiment, the specific processing of the acquiring unit 501, the determining unit 502, and the matching unit 503 of the apparatus 500 for determining road information and the technical effects thereof may be described with reference to the related description of step 201, step 202, and step 203 in the corresponding embodiment of FIG. 2, respectively, and are not repeated here.

In some alternative implementations of the present embodiment, the matching unit is further configured to execute the obtaining the road information by the matching, wherein the positioning error value between the road information and the current positioning information satisfies the positioning error threshold by: uploading a threshold updating request to a server, and receiving update information about the positioning error threshold returned from the server; and updating the positioning error threshold using the update information to obtain an updated positioning error threshold, and obtaining the road information by matching, wherein the positioning error value between the road information and the current positioning information satisfies the updated positioning error threshold.

In some alternative implementations of the present embodiment, the threshold updating request includes a trajectory of the terminal and the target road information; and the matching unit is further configured to execute the uploading the threshold updating request to the server by: uploading the threshold updating request to the server, where the server determines, based on the trajectory, the road information of the terminal as reference road information, and generates the update information about the positioning error threshold based on the reference road information and the target road information.

In some alternative implementations of the present embodiment, the apparatus further includes: a generating unit configured to, after the determining the positioning error threshold of the current positioning information, generate a new positioning error threshold based on the following parameters of a current road matching cycle: a positioning error threshold determined by the terminal, a confidence of the positioning error threshold, the number of iterations of the positioning error threshold at the terminal, a reference positioning error threshold determined by the server, a confidence of the reference positioning error threshold, and the number of iterations of the positioning error threshold at the server.

In some alternative implementations of the present embodiment, the generating the reference positioning error threshold includes: generating the reference positioning error threshold based on the following parameters of the current road matching cycle: the positioning error threshold determined by the terminal, timeliness of the positioning error threshold, the number of iterations of the positioning error threshold at the terminal, a to-be-corrected positioning error threshold determined by the server, timeliness of the to-be-corrected positioning error threshold, and the number of iterations of the to-be-corrected positioning error threshold at the server.

In some alternative implementations of the present embodiment, the positioning error threshold includes a confidence threshold, and the positioning error value includes a distance error and an angle error; and the apparatus further includes: an information determining unit configured to determine at least two candidate road information of the terminal based on the current positioning information; and the matching unit is further configured to execute the obtaining the road information for use as the target road information by the matching, wherein the positioning error value between the road information and the current positioning information satisfies the positioning error threshold by: performing preset processing on the distance error and the angle error, where, for the distance error and the angle error, the higher a value of the distance error or the angle error is, the smaller a result obtained by the preset processing is; weighting the distance error obtained by the preset processing and the angle error obtained by the preset processing, and using weighting results as a road binding confidence; and obtaining second road information from the at least two candidate road information for use as the target road information by matching, wherein a road binding confidence reaches the confidence threshold.

In some alternative implementations of the present embodiment, the historical positioning error value includes a distance error variance and an angle error variance; and the apparatus further includes: a weight determining unit configured to determine, for the at least two candidate road information, a weight of the distance error and a weight of the angle error based on the distance error variance and the angle error variance.

In some alternative implementations of the present embodiment, the positioning error threshold further includes a distance error threshold and an angle error threshold; and the matching unit is further configured to execute the obtaining the second road information for use as the target road information by matching, wherein the road binding confidence reaches the confidence threshold by: obtaining candidate road information by matching, wherein for the candidate road information, the distance error obtained by the preset processing reaches the distance error threshold, an angle error obtained by the preset processing reaches the angle error threshold, and a road binding confidence reaches the confidence threshold, and using road information corresponding to the candidate road information as the target road information.

In some alternative implementations of the present embodiment, the determining unit is further configured to execute the determining the positioning error threshold of the current positioning information based on the historical positioning error value of the historical positioning information of the terminal in the latest preset historical period by: acquiring a current road type of the terminal; and determining the positioning error threshold of the current positioning information based on the historical positioning error value and the current road type.

In some alternative implementations of the present embodiment, the determining unit is further configured to execute the acquiring the current road type of the terminal by: using a road type of the target road information matched in a previous road matching cycle as the current road type.

In some alternative implementations of the present embodiment, the road information is a road network unit, a driving route unit, or positioning information; and the matching unit is further configured to execute the obtaining the road information by the matching, wherein the positioning error value between the road information and the current positioning information satisfies the positioning error threshold by: matching the current positioning information with the driving route unit; using, in response to obtaining a matching driving route unit, the matching driving route unit as the target road information; and matching, in response to not obtaining the matching driving route unit, the positioning information with the road network unit; using, in response to obtaining a matching road network unit, the matching road network unit as the target road information; and using, in response to not obtaining the matching road network unit, the current positioning information as the target road information.

According to an embodiment of the present disclosure, the present disclosure further provides an electronic device, a readable storage medium, and a computer program product.

As shown in FIG. 6, a block diagram of an electronic device of the method for determining road information according to embodiments of the present disclosure is shown. The electronic device is intended to represent various forms of digital computers, such as a laptop computer, a desktop computer, a workbench, a personal digital assistant, a server, a blade server, a mainframe computer, and other suitable computers. The electronic device may also represent various forms of mobile apparatuses, such as a personal digital assistant, a cellular phone, a smart phone, a wearable device, and other similar computing apparatuses. The components shown herein, the connections and relationships thereof, and the functions thereof are used as examples only, and are not intended to limit implementations of the present disclosure described and/or claimed herein.

As shown in FIG. 6, the electronic device includes: one or more processors 601, a memory 602, and interfaces for connecting various components, including a high-speed interface and a low-speed interface. The various components are interconnected using different buses, and may be mounted on a common motherboard or in other manners as required. The processor may process instructions for execution within the electronic device, including instructions stored in the memory or on the memory to display graphical information for a GUI on an external input/output apparatus (e.g., a display device coupled to an interface). In other implementations, a plurality of processors and/or a plurality of buses may be used, as appropriate, along with a plurality of memories and a plurality of memories. Similarly, a plurality of electronic devices may be connected, with each device providing portions of necessary operations (e.g., as a server array, a group of blade servers, or a multi-processor system). In FIG. 6, a processor 601 is taken as an example.

The memory 602 is a non-transient computer readable storage medium provided in the present disclosure. The memory stores instructions executable by at least one processor, such that the at least one processor executes the method for determining road information provided in the present disclosure. The non-transient computer readable storage medium of the present disclosure stores computer instructions. The computer instructions are used for causing a computer to execute the method for determining road information provided in the present disclosure.

As a non-transient computer readable storage medium, the memory 602 may be configured to store non-transient software programs, non-transient computer executable programs and modules, such as the program instructions/modules (e.g., the acquiring unit 501, the determining unit 502, and the matching unit 503 shown in FIG. 5) corresponding to the method for determining road information in some embodiments of the present disclosure. The processor 601 runs non-transient software programs, instructions, and modules stored in the memory 602, so as to execute various function applications and data processing of a server, i.e., implementing the method for determining road information in the above embodiments of the method.

The memory 602 may include a program storage area and a data storage area, where the program storage area may store an operating system and an application program required by at least one function; and the data storage area may store, e.g., data created based on use of the electronic device for determining road information. In addition, the memory 602 may include a high-speed random access memory, and may further include a non-transitory memory, such as at least one disk storage component, a flash memory component, or other non-transitory solid state storage components. In some embodiments, the memory 602 alternatively includes memories remotely disposed relative to the processor 601, and these remote memories may be connected to the electronic device for determining road information via a network. Examples of the above network include, but are not limited to, the Internet, an intranet, a local area network, a mobile communication network, and a combination thereof.

The electronic device of the method for determining road information may further include: an input apparatus 603 and an output apparatus 604. The processor 601, the memory 602, the input apparatus 603, and the output apparatus 604 may be connected through a bus or in other manners. Bus connection is taken as an example in FIG. 6.

The input apparatus 603 may receive inputted number or character information, and generate a key signal input related to user settings and function control of the electronic device for determining road information, e.g., an input apparatus such as a touch screen, a keypad, a mouse, a trackpad, a touchpad, an indicating arm, one or more mouse buttons, a trackball, and a joystick. The output apparatus 604 may include a display device, an auxiliary lighting apparatus (e.g., an LED), a haptic feedback apparatus (e.g., a vibration motor), and the like. The display device may include, but is not limited to, a liquid crystal display (LCD), a light emitting diode (LED) display, and a plasma display. In some implementations, the display device may be a touch screen.

Various implementations of the systems and technologies described herein may be implemented in a digital electronic circuit system, an integrated circuit system, an ASIC (application specific integrated circuit), computer hardware, firmware, software, and/or a combination thereof. The various implementations may include: being implemented in one or more computer programs, where the one or more computer programs may be executed and/or interpreted on a programmable system including at least one programmable processor, and the programmable processor may be a specific-purpose or general-purpose programmable processor, which may receive data and instructions from a storage system, at least one input apparatus and at least one output apparatus, and send the data and instructions to the storage system, the at least one input apparatus and the at least one output apparatus.

These computing programs (also known as programs, software, software applications, or code) include machine instructions for a programmable processor, and may be implemented in a high-level procedural and/or object-oriented programming language, and/or in an assembly/machine language. As used herein, the terms “machine readable medium” and “computer readable medium” refer to any computer program product, device, and/or apparatus (e.g., a magnetic disk, an optical disk, a memory, or a programmable logic device (PLD)) configured to provide machine instructions and/or data to a programmable processor, and include a machine readable medium receiving machine instructions as machine readable signals. The term “machine readable signal” refers to any signal used to provide machine instructions and/or data to a programmable processor.

To provide interaction with a user, the systems and technologies described herein may be implemented on a computer that is provided with: a display apparatus (e.g., a CRT (cathode ray tube) or an LCD (liquid crystal display) monitor) configured to display information to the user; and a keyboard and a pointing apparatus (e.g., a mouse or a trackball) by which the user can provide an input to the computer. Other kinds of apparatuses may also be configured to provide interaction with the user. For example, feedback provided to the user may be any form of sensory feedback (e.g., visual feedback, auditory feedback, or tactile feedback); and an input may be received from the user in any form (including an acoustic input, a voice input, or a tactile input).

The systems and technologies described herein may be implemented in a computing system that includes a back-end component (e.g., as a data server), or a computing system that includes a middleware component (e.g., an application server), or a computing system that includes a front-end component (e.g., a user computer with a graphical user interface or a web browser through which the user can interact with an implementation of the systems and technologies described herein), or a computing system that includes any combination of such a back-end component, such a middleware component, or such a front-end component. The components of the system may be interconnected by digital data communication (e.g., a communication network) in any form or medium. Examples of the communication network include: a local area network (LAN), a wide area network (WAN), and the Internet.

The computer system may include a client and a server. The client and the server are generally remote from each other, and generally interact with each other through a communication network. The relationship between the client and the server is generated by virtue of computer programs that run on corresponding computers and have a client-server relationship with each other. The server may be a cloud server, which is also known as a cloud computing server or a cloud host, and is a host product in a cloud computing service system to solve the defects of difficult management and weak service extendibility existing in conventional physical hosts and VPS services (“virtual private server”, or “VPS” for short). The server may also be a distributed system server, or a server combined with a blockchain.

The flow charts and block diagrams in the accompanying drawings illustrate architectures, functions and operations that may be implemented according to the systems, methods and computer program products of the various embodiments of the present disclosure. In this regard, each of the blocks in the flow charts or block diagrams may represent a module, a program segment, or a code portion, said module, program segment, or code portion including one or more executable instructions for implementing specified logic functions. It should also be noted that, in some alternative implementations, the functions denoted by the blocks may occur in a sequence different from the sequences shown in the figures. For example, any two blocks presented in succession may be executed substantially in parallel, or sometimes be executed in a reverse sequence, depending on the functions involved. It should also be noted that each block in the block diagrams and/or flow charts as well as a combination of blocks in the block diagrams and/or flow charts may be implemented using a dedicated hardware-based system executing specified functions or operations, or by a combination of dedicated hardware and computer instructions.

The units involved in the embodiments of the present disclosure may be implemented by software or hardware. The described units may also be provided in a processor, for example, described as: a processor including an acquiring unit, a determining unit, and a matching unit. The names of these units do not constitute a limitation to such units themselves in some cases. For example, the acquiring unit may be further described as “a unit configured to acquire current positioning information of a terminal.”

In another aspect, the present disclosure further provides a computer readable medium. The computer readable medium may be included in the apparatus described in the above embodiments, or a stand-alone computer readable medium without being assembled into the apparatus. The computer readable medium carries one or more programs. The one or more programs, when executed by the apparatus, cause the apparatus to: acquire current positioning information of a terminal; determine a positioning error threshold of the current positioning information based on a historical positioning error value of historical positioning information of the terminal in a latest preset historical period; and obtain road information for use as target road information by matching, wherein a positioning error value between the road information and the current positioning information satisfies the positioning error threshold, and the road information includes at least one of: a road network unit, a driving route unit, or the current positioning information.

The above description only provides explanation of the preferred embodiments and the employed technical principles of the present disclosure. It should be appreciated by those skilled in the art that the inventive scope of the present disclosure is not limited to the technical solutions formed by the particular combinations of the above-described technical features. The inventive scope should also cover other technical solutions formed by any combinations of the above-described technical features or equivalent features thereof without departing from the concept of the disclosure, for example, technical solutions formed by interchanging the above-described features with, but not limited to, technical features with similar functions disclosed in the present disclosure.

What is claimed is:

1. A method for determining road information, applied to a terminal, the method comprising:
acquiring current positioning information of the terminal;
determining a positioning error threshold of the current positioning information based on a historical positioning error value of historical positioning information of the terminal in a latest preset historical period; and
obtaining road information for use as target road information by matching, wherein a positioning error value between the road information and the current positioning information satisfies the positioning error threshold, and the road information includes at least one of: a road network unit, a driving route unit, or the current positioning information.

2. The method according to claim 1, wherein the obtaining the road information by the matching, wherein the positioning error value between the road information and the current positioning information satisfies the positioning error threshold, comprises:
uploading a threshold updating request to a server, and receiving update information about the positioning error threshold returned from the server; and
updating the positioning error threshold using the update information to obtain an updated positioning error threshold, and obtaining road information by matching, wherein the positioning error value between the road information and the current positioning information satisfies the updated positioning error threshold.

3. The method according to claim 2, wherein the threshold updating request comprises a trajectory of the terminal and the target road information; and
the uploading the threshold updating request to the server comprises:
uploading the threshold updating request to the server, wherein the server determines, based on the trajectory, the road information of the terminal as reference road information, and generates the update information about the positioning error threshold based on the reference road information and the target road information.

4. The method according to claim 1, wherein after the determining the positioning error threshold of the current positioning information, the method further comprises:
generating a new positioning error threshold based on following parameters of a current road matching cycle:
a positioning error threshold determined by the terminal, a confidence of the positioning error threshold, a number of iterations of the positioning error threshold at the terminal, a reference positioning error threshold determined by a server, a confidence of the reference positioning error threshold, and a number of iterations of the reference positioning error threshold at the server.

5. The method according to claim 4, wherein the generating the reference positioning error threshold comprises:
generating the reference positioning error threshold based on following parameters of the current road matching cycle:
the positioning error threshold determined by the terminal, timeliness of the positioning error threshold, the number of iterations of the positioning error threshold at the terminal, a to-be-corrected positioning error threshold determined by the server, timeliness of the to-be-corrected positioning error threshold, and the number of iterations of the to-be-corrected positioning error threshold at the server.

6. The method according to claim 1, wherein the positioning error threshold comprises a confidence threshold, and the positioning error value comprises a distance error and an angle error; and
the method further comprises: determining at least two candidate road information of the terminal based on the current positioning information; and
the obtaining the road information for use as the target road information by the matching, wherein the positioning error value between the road information and the current positioning information satisfies the positioning error threshold, comprises:
performing preset processing on the distance error and the angle error, wherein, for the distance error and the angle error, the higher a value of the distance error or the angle error is, the smaller a result obtained by the preset processing is;
weighting the distance error obtained by the preset processing and the angle error obtained by the preset processing, and using weighting results as a road binding confidence; and
obtaining second road information from the at least two candidate road information for use as the target road information by matching, wherein a road binding confidence of the second road information reaches the confidence threshold.

7. The method according to claim 6, wherein the historical positioning error value comprises a distance error variance and an angle error variance; and
the method further comprises:
determining, for the at least two candidate road information, a weight of the distance error and a weight of the angle error based on the distance error variance and the angle error variance.

8. The method according to claim 6, wherein the positioning error threshold further comprises a distance error threshold and an angle error threshold; and
the obtaining the second road information for use as the target road information by the matching, wherein the road binding confidence of the second road information reaches the confidence threshold, comprises:
obtaining candidate road information by matching, wherein for the candidate road information, the distance error obtained by the preset processing reaches the distance error threshold, the angle error obtained by the preset processing reaches the angle error threshold, and the road binding confidence reaches the confidence threshold; and
using road information corresponding to the candidate road information as the target road information.

9. The method according to claim 1, wherein the determining the positioning error threshold of the current positioning information based on the historical positioning error value of the historical positioning information of the terminal in the latest preset historical period comprises:
acquiring a current road type of the terminal; and
determining the positioning error threshold of the current positioning information based on the historical positioning error value and the current road type.

10. The method according to claim 9, wherein the acquiring the current road type of the terminal comprises:
using a road type of the target road information matched in a previous road matching cycle as the current road type.

11. The method according to claim 1, wherein the road information is the road network unit, the driving route unit, or the positioning information; and
the obtaining the road information by the matching, wherein the positioning error value between the road information and current positioning information satisfies the positioning error threshold, comprises:
matching the current positioning information with the driving route unit;
using, in response to obtaining a matching driving route unit, the matching driving route unit as the target road information; and
matching, in response to not obtaining the matching driving route unit, the positioning information with the road network unit; using, in response to obtaining a matching road network unit, the matching road network unit as the target road information; and using, in response to not obtaining the matching road network unit, the current positioning information as the target road information.

12. An electronic device, comprising:
at least one processor; and
a memory communicatively connected to the at least one processor; wherein
the memory stores instructions executable by the at least one processor, and the instructions, when executed by the at least one processor, cause the at least one processor to perform operations comprising:
acquiring current positioning information of a terminal;
determining a positioning error threshold of the current positioning information based on a historical positioning error value of historical positioning information of the terminal in a latest preset historical period; and
obtaining road information for use as target road information by matching, wherein a positioning error value between the road information and the current positioning information satisfies the positioning error threshold, and the road information includes at least one of: a road network unit, a driving route unit, or the current positioning information.

13. The electronic device according to claim 12, wherein the obtaining the road information by the matching, wherein the positioning error value between the road information and the current positioning information satisfies the positioning error threshold, comprises:
uploading a threshold updating request to a server, and receiving update information about the positioning error threshold returned from the server; and
updating the positioning error threshold using the update information to obtain an updated positioning error threshold, and obtaining road information by matching, wherein the positioning error value between the road information and the current positioning information satisfies the updated positioning error threshold.

14. The electronic device according to claim 13, wherein the threshold updating request comprises a trajectory of the terminal and the target road information; and
the uploading the threshold updating request to the server comprises:
uploading the threshold updating request to the server, wherein the server determines, based on the trajectory, the road information of the terminal as reference road information, and generates the update information about the positioning error threshold based on the reference road information and the target road information.

15. The electronic device according to claim 12, wherein after the determining the positioning error threshold of the current positioning information, the operations further comprise:
generating a new positioning error threshold based on following parameters of a current road matching cycle:
a positioning error threshold determined by the terminal, a confidence of the positioning error threshold, a number of iterations of the positioning error threshold at the terminal, a reference positioning error threshold determined by a server, a confidence of the reference positioning error threshold, and a number of iterations of the reference positioning error threshold at the server.

16. The electronic device according to claim 15, wherein the generating the reference positioning error threshold comprises:
generating the reference positioning error threshold based on following parameters of the current road matching cycle:
the positioning error threshold determined by the terminal, timeliness of the positioning error threshold, the number of iterations of the positioning error threshold at the terminal, a to-be-corrected positioning error threshold determined by the server, timeliness of the to-be-corrected positioning error threshold, and the number of iterations of the to-be-corrected positioning error threshold at the server.

17. The electronic device according to claim 12, wherein the positioning error threshold comprises a confidence threshold, and the positioning error value comprises a distance error and an angle error; and
the operations further comprise: determining at least two candidate road information of the terminal based on the current positioning information; and
the obtaining the road information for use as the target road information by the matching, wherein the positioning error value between the road information and the current positioning information satisfies the positioning error threshold, comprises:
performing preset processing on the distance error and the angle error, wherein, for the distance error and the angle error, the higher a value of the distance error or the angle error is, the smaller a result obtained by the preset processing is;
weighting the distance error obtained by the preset processing and the angle error obtained by the preset processing, and using weighting results as a road binding confidence; and
obtaining second road information from the at least two candidate road information for use as the target road information by matching, wherein a road binding confidence of the second road information reaches the confidence threshold.

18. The electronic device according to claim 17, wherein the historical positioning error value comprises a distance error variance and an angle error variance; and
the operations further comprise:
determining, for the at least two candidate road information, a weight of the distance error and a weight of the angle error based on the distance error variance and the angle error variance.

19. The electronic device according to claim 17, wherein the positioning error threshold further comprises a distance error threshold and an angle error threshold; and
the obtaining the second road information for use as the target road information by the matching, wherein the road binding confidence of the second road information reaches the confidence threshold, comprises:
obtaining candidate road information by matching, wherein for the candidate road information, the distance error obtained by the preset processing reaches the distance error threshold, the angle error obtained by the preset processing reaches the angle error threshold, and the road binding confidence reaches the confidence threshold; and
using road information corresponding to the candidate road information as the target road information.

20. A non-transitory computer readable storage medium storing computer instructions, wherein the computer instructions are used for causing a computer to perform operations comprising:
acquiring current positioning information of a terminal;
determining a positioning error threshold of the current positioning information based on a historical positioning error value of historical positioning information of the terminal in a latest preset historical period; and
obtaining road information for use as target road information by matching, wherein a positioning error value between the road information and the current positioning information satisfies the positioning error threshold, and the road information includes at least one of: a road network unit, a driving route unit, or the current positioning information.
